(19) United States
(12) Patent Application Publication
(10) Pub. No.: US 2011/0272166 A1
(43) Pub. Date: Nov. 10, 2011

(54) Separation Under Pressure of Methane from Hot Brine Useful for Geothermal Power

(76) Inventor: Robert Daniel Hunt, Long Beach, MS (US)

(21) Appl. No.: 13/156,711

(22) Filed: Jun. 9, 2011

(51) Int. Cl. E21B 43/16

(52) U.S. Cl. 166/402

(57) ABSTRACT

A gas-stripping method of separating methane from pressurized brine while under pressure with the simultaneous gas-lift pumping production of hot water capable of generating geothermal power whereby liquid carbon dioxide pumped to high pressure is injected at depth into a flow of pressurized brine located within a wellbore that is in fluid connection with a reservoir of brine solution containing methane in order to saturate the methane saturated brine with miscible liquid carbon dioxide and to gas-strip the methane from the brine as the liquid carbon dioxide boils to the gas phase in response to the thermal energy contained within the hot brine thereby effectively separating the methane from the brine water under pressure and in order to simultaneously gas-lift pressurized methane containing water from the reservoir by lowing the density of the column of water within the well. A separator pressure vessel collects and separates the liquids from the gases discharged from the well; and a second vessel separates the pressurized methane gas and high vapor pressure carbon dioxide gas by cooling and condensing the carbon dioxide gas to the liquid phase in a semi-closed cycle, being a means conserving and reusing the supply of carbon dioxide. And, geothermal power is generated using the thermal energy contained in the pressurized hot water using conventional ORC technology; and, the kinetic energy of the total flow of pressurized gases and liquids discharged from the well are harnessed by a suitable prime mover, such as a free-piston engine. The high vapor pressure of the carbon dioxide gas in the separator compresses the methane gas such that additional compression is not needed for the natural gas to flow into gas transmission lines to market; and, the high vapor pressure provides force to pressurize the brine back into the aquifer without the need for supplemental pumping energy input.

### BACKGROUND

Mechanical separation of methane from pressurized hot brine solution normally requires significant reduction in pressure to below five atmospheres of pressure (73.5 psi) to allow the majority of natural gas dissolved into the brine to dissipate out of the brine due to the low pressure. All of the gas is not removed by the process. For all of the gas to be extracted, the brine must be reduced to below atmospheric pressure. The result of this low pressure mechanical process is that the gas generally must be compressed to a much higher pressure, usually 600 psi or greater, sufficient to enter natural gas transmission lines; and, the low pressure brine solution with the methane removed must generally be pumped to high pressure for disposal in an injection well.

Both compression of the methane and pumping of the water require substantial power. Therefore, it is desirable to develop a method to allow separation of methane from brine solution at significantly higher pressure on the order of 600 psi or higher so that the methane gas can flow into the gas transmission line without compression and so that the water can be injected into a disposal well without the need of pumping to increase its pressure. Such a process for the separation of methane from brine under pressure would especially be useful in the separation of natural gas from hot brine resources having geopressure or useful in association with pressurized brine solutions that are gas-lift pumped using high vapor pressure working fluids that can cause artificially high pressure to occur during the process. High vapor pressure propane, ethane or carbon dioxide are often used for this purpose.

Carbon dioxide is a naturally occurring substance. At higher temperatures than its critical temperature (31.1° C./87.9° F.) and critical pressure (72.9 atm./7.39 MPa/1071.3 psi), it behaves as a supercritical fluid—expanding to fill its container like a gas but with a density like that of a liquid. Supercritical carbon dioxide is an important commercial and industrial solvent due to its role in chemical extraction in addition to its low toxicity and environmental impact. The relatively low temperature of the process and the stability of carbon dioxide also allows most compounds to be extracted with little damage or denaturing. It is also an important substance widely used in enhanced oil and gas recovery due to its ability to strip natural gas out of solution with brine under pressure and its ability to reduce the viscosity of oil in order to allow it to flow to production wells. When carbon dioxide is dissolved in brine saturated with methane, almost all of the methane comes out of solution and forms a free gas phase of almost pure methane even while under substantial pressure.

Enhanced oil and gas recovery projects often flood large aquifers with carbon dioxide. The process separates methane from the brine solution underground while under pressure. However, this prior art process requires vast quantities of carbon dioxide and can cause environmental concerns such as excess reservoir pressure build-up that could potentially be responsible for unwanted seismic activity while injecting large amounts of carbon dioxide into aquifers. It is desirable to develop a method to extract methane from brine under pressure without the need of a large continuous supply of carbon dioxide and without the need of flooding an entire reservoir with nitrogen or carbon dioxide as has been used in prior art enhanced oil and gas recovery methods; and, it is desirable to be able to effectively reuse the working fluid over and over by using a closed or nearly sealed semi-closed process.

Prior Art U. S. Pat. No. 4,741,398 titled, “Hydraulic accumulator-compressor for geopressured enhanced oil recovery” dated May, 3, 1988 by Goldsberry discloses a means of separation of methane from pressurized brine by sufficiently reducing the pressure to allow mechanical separation of the methane from solution. Then, the brine and resulting free methane gas separated are re-pressurized by alternately using two hydraulic accumulator-compressors powered by force applied by the brine geopressure as the energy source. While this prior art patent provides a means for re-pressurizing the methane gas and brine, it does not accomplish methane separation under pressure, which is more desirable than mere pressurization using the force of a new supply of high pressure brine fluid, which may be used in a more beneficial manner to produce useful power.

A significant fraction of the deep, high-temperature underground aquifers are saturated with methane (CH4) at pressures exceeding normal hydrostatic pressure and are thus referred to as having geopressure. This type of reservoir is common and many are well defined along the Gulf Coast of Texas and Louisiana but also exist along the Mississippi, Alabama and Florida coasts and in the offshore waters of the Gulf of Mexico. California has a significant number of geopressured aquifers as do many other sedimentary basins through the world.

The methane content of the saturated brines typically measured in geopressured, geothermal reservoirs is on the order of 30 STF per barrel of brine. Although this is a very small concentration, the total amount of methane is enormous (estimates range from 3000 to 46,000 TCF) due to the vast volumes of these aquifers. Using this value, and a pore volume of one billion barrels for a relatively small aquifer, the volume of dissolved methane is 30 trillion cubic feet having a value of $120 million at the price of $4 per thousand cubic feet. The thermal energy content of the hot brine is also of significant economic value as a renewable energy resource that in many cases may exceed the value of the natural gas extraction potential. The force provided by geopressure produced by high pressure reservoirs is a third important and economically valuable renewable energy power resource that may be also be commercially exploited.

### DISCLOSURE

The present patent presents a method to separate under pressure the dissolved methane from the hot brine by gas-stripping the methane away from the brine using pressurized carbon dioxide gas that is further used for gas-lift pumping of brine from production wells that are fluidly connected to large aquifers that contain vast amounts of brine saturated with methane. However, using the process of the present invention, the gas-stripping/gas-lifting carbon dioxide is only injected into the wellbore and there is no need of flooding the entire reservoir with working fluid as is used in prior art enhanced oil and gas recovery processes.

Pumping is not required for the production of methane saturated brine if the reservoir pressure is a geopressured, geothermal reservoir. However, the gas-lift pumping process significantly adds to the net amount of hot brine produced from such geopressured wells. And, the result is that additional natural gas production and geothermal power output are thereby achieved due to the far greater volume of brine produced from these wells using the gas-lift process that beneficially pumps more brine than is produced by geopressure along—while it simultaneously gas-strips methane under pressure from the hot brine during the process. Using the method of present invention disclosed herein, the force provided by the geopressure produced by high pressure reservoirs is enhanced by the gas-lift process and is then harnessed.

Gas-lifted geopressure wells flow with dramatically improved flow rates and with much greater force; and, the process causes wells that do not have geopressure to free flow with substantial pressure due to the extremely high vapor pressure of the carbon dioxide gas. For example, the vapor pressure of carbon dioxide at the boiling point of pure water while at atmospheric pressure of 212 deg. F. exceeds 3,600 psi being sufficient to displace high mass brine solution water with low mass carbon dioxide gas at over 8,000 feet of depth, which results in the weight of the column of water being lowered thereby becoming less dense. The brine applies a downward hydrostatic force opposing the upward force of the pressure of the reservoir. The net result is that the pressure of the reservoir remains the same while the weight of the lowered density column of brine within the well bore drops and gas-lift pumping of the brine is achieved

Using the gas-lift procedure for brine pumping and for gas-stripping of methane from the brine within a wellbore, a pressurized total flow comprising: large quantities of hot brine useful for geothermal power generation; free methane gas after being gas-stripped and separated from the brine; and, high vapor pressure carbon dioxide gas is achieved, which all flow to the surface with great force having a large amount of kinetic energy. The large quantity of kinetic energy produced by this pressurized total flow of the liquids and gases is capable of generating substantial power and may be used to drive a prime mover to generate electrical power. Then these constituents are separated and the carbon dioxide is beneficially reused in a semi-closed cycle that dramatically reduces the amount of working fluid needed to operate the process. The thermal energy contained in the separated hot brine solution is capable of generating geothermal power using a conventional organic Rankine cycle (ORC) geothermal power unit.

The “total flow concept” is an unconventional geothermal technology that harnesses the kinetic energy in the total flow of pressurized gases and liquids discharged from the well by a suitable prime mover, such as a free-piston engine, in order to generate mechanical power. Produced power may be used to drive the process by powering working fluid liquid pumps to pump liquid carbon dioxide to high pressure and/or gas compressors to compress gaseous carbon dioxide to high pressure; to power other equipment used to separate the methane from the brine; and used to power electrical generators. And additional electrical power may be used onsite or sold to the local utility.

The gas-lift process beneficially works on wells that do not possess geopressure and do not free flow, which substantially increases the number of wells suitable to be used by the process of the present invention due to its gas-lift pumping capabilities. Even using gas-lift, wells that do not free flow and with their water level substantially below the surface may not flow with sufficient pressure and force to allow generation of power from the kinetic energy of the total flow of fluids from the well because residual pressure is required to compress the methane gas and is required to pressurize the water into the injection well and there may not be enough pressure to accomplish both tasks. This type of well can still however beneficially generate geothermal power from the thermal energy contained in the hot brine while simultaneously separating methane from hot brine. This process is illustrated in schematic FIG. 1.

FIG. 2 is a schematic diagram of the preferred embodiment of the apparatus for gas-stripping methane (CH4) from brine solution under pressure within a well bore, with the generation of geothermal power from the thermal energy contained in the produced hot brine and with the generation of mechanical power produced using a free-piston engine to harness the kinetic energy of the total flow of pressurized fluids discharged from the well. Carbon dioxide is used as a gas stripping/gas-lifting working fluid to strip and remove the methane from the brine under pressure and to simultaneously gas-lift pump the hot brine from the wellbore by reducing the density of the brine. The carbon dioxide gas is condensed to the liquid phase in order to separate the methane gas from the gaseous carbon dioxide in a semi-closed cycle in order to reduce and conserve the amount of carbon dioxide working fluid required to operate the semi-closed process, which is a significant improvement over conventional enhanced oil and gas recovery prior art methods.

### DESCRIPTION OF THE DRAWINGS

FIG. 1 describes the herein disclosed method of separating methane (100) from hot brine (104) while under pressure with the generation of geothermal power using gaseous phase carbon dioxide (102) as the stripping gas/lifting gas working fluid. Liquid phase carbon dioxide (102) is pumped to high pressure by a carbon dioxide liquid pump (106) that flows through liquid injection lines (108), being a coiled tubing or pipe stringer, extending at depth into a gas well (110) that penetrates through the sand and rocks of the earth (118) to a deep underground aquifer (112) containing large quantities of methane saturated brine water (104). The liquid miscible carbon dioxide (102) is pressurized into the flow of brine solution (104) and saturates the brine solution (104); then by direct heat exchange with the brine (104) the liquid carbon dioxide (102) boils to a high vapor pressure being a pressure equalizing gas in response to the thermal energy contained in the brine (104); and, thereby strips and separates the methane (100) from solution with the brine (104) as free methane gas (100) while under substantial pressure deep within the bore of the well (110).

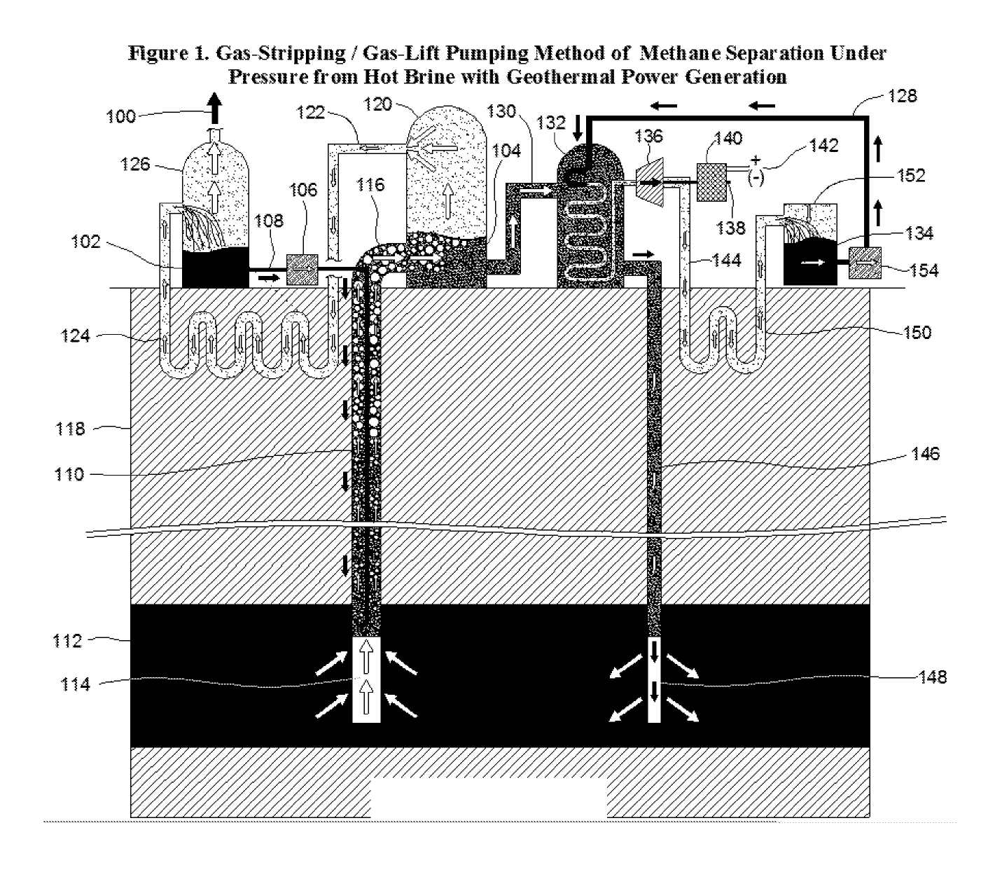

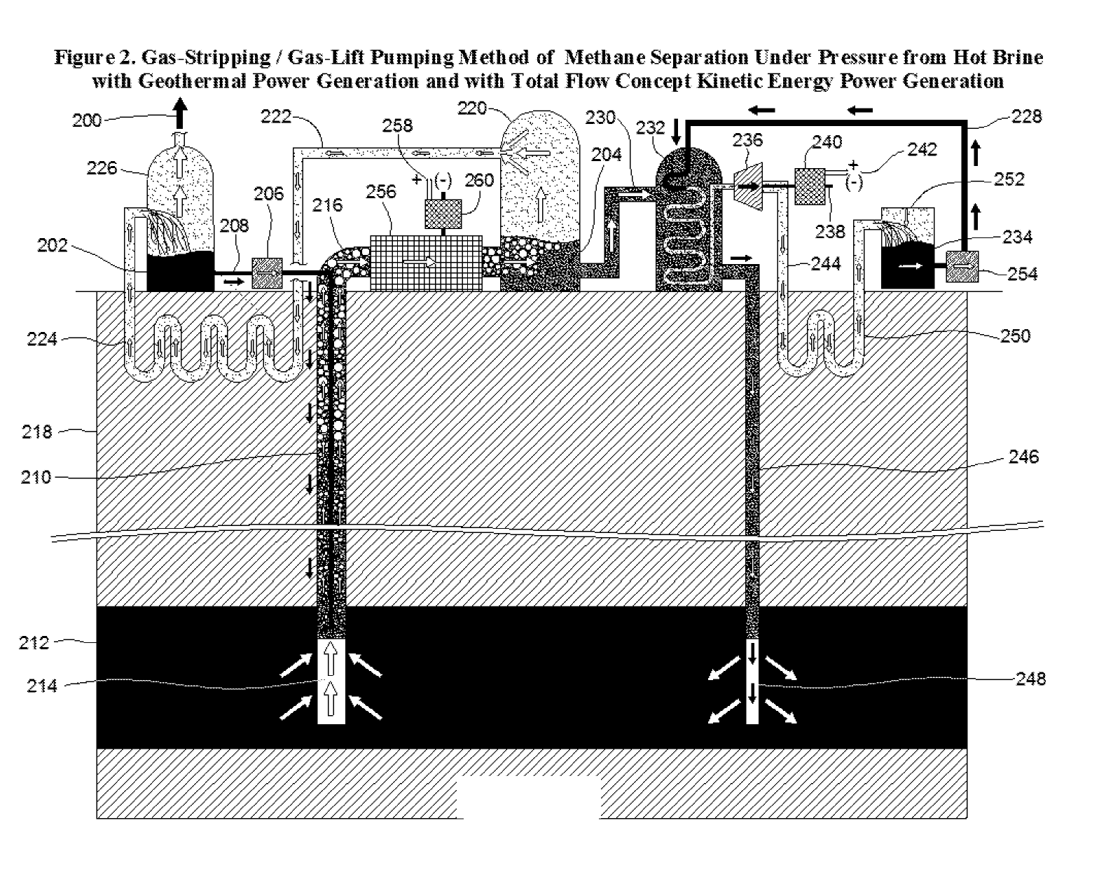

The brine (104) flows from the reservoir (112) that is a the permeable aquifer (112) filled with methane (100) saturated brine solution (104) through the screen (114) or other forms of penetrations in the casing of the well (110). A total flow (116) of brine, methane gas (100), and carbon dioxide gas (102) under pressure are discharged from the well's casing (110) and flow into a separator pressure vessel (120) located at the surface of the earth (118). The difference in densities of the heavy liquid brine (104) and any other liquids that may be present such as heavy tar and oil as compared to the low density, light weight gases (100 & 102) allow the separator (120) to cause physical separation of the substances with the brine (104) being at the bottom of the unit (120) and the gases (100 & 102) being above the water (104) due to the differential in their specific densities.

The hot pressurized gases (100 & 102) flow out of the top of the separator (120) being at relatively high pressure into lines (122) to a ground loop heat exchanger (124) that rejects heat from the gases (100 & 102) to the shallow earth (118) just below the surface that remains at a cool (relative the temperature of the hot brine) near constant temperature year round. Cooling under pressure causes condensation of the carbon dioxide gas (102) to the liquid state while the natural gas (100) remains in the gaseous state. The liquid carbon dioxide (102) and the gaseous methane (100) flow into methane separator (126) and the relative specific densities of the two substances again allows separation. The pure methane gas (100) flows out of the separator under pressure such that additional compression is not needed for it to flow into gas transmission lines (not shown) where it is delivered to market. The liquid carbon dioxide (102) is withdrawn from the methane separator (126) into injector lines (108) by the liquid pump (106) and is pumped to higher pressure to again be injected into the flow of brine (104) at depth within the well (110) in a semi-closed continuous cycle that conserves the carbon dioxide working fluid (102).

The pressurized brine (104) after the methane (100) has been removed flows from the separator (120) flows through lines (130) in indirect heat exchange vaporizer (132) of an geothermal power unit organic Rankine cycle (ORC) in order to generate geothermal power using the thermal energy contained in the hot pressurized brine (104). Then flows to the spent brine injection well (146) and is discharged back into the aquifer (112) through screens (148) or other penetrations in the casing of the well (110) using its residual remaining pressure for reinjection without the need for supplemental pumping energy input. If the reservoir (112) has substantial geopressure the brine (112) would normally be placed in a shallower reservoir having less pressure. However, if the brine (104) is withdrawn by gas-lift pumping from the reservoir (112) at below or near hydrostatic pressure, it can easily flow back into same reservoir (112) using the artificial pressure produced by the high vapor pressure of the carbon dioxide gas (102).

The ORC liquid pump (154) withdraws liquid phase organic working fluid (134) from liquid reservoir (152) and pressurizes it through lines (128) into vaporizer (132) where the liquid (134) is vaporized into a pressurized gas (134) that flows to turbine (136) connected by a shaft (138) to an electrical generator (140) having an electrical power output (142). The spent working fluid (134) discharged from turbine (136) flows through lines (144) into a ground loop indirect heat exchanger (150) in order to reject heat to the near surface earth (118) that results in condensation of the working fluid (134) back to the liquid state, which then flows into liquid reservoir (152) to be pressurized by the liquid pump (154) in a continuous closed ORC cycle in order to generate geothermal power from the thermal energy contained in the brine (104). Power generated by the ORC unit may be used to drive the process by directly powering working fluid liquid pumps (106) to pump liquid carbon dioxide (102) to high pressure and/or gas compressors (not shown) to compress gaseous carbon dioxide (102) to high pressure; to power other equipment (not shown if any) used to separate the methane (100) from the brine (102). Electrical power output (142) may be used onsite or sold to the local utility.

FIG. 2 describes the preferred embodiment of the herein disclosed method of separating methane (200) from hot brine (204) while under pressure using gaseous phase carbon dioxide (202) as the stripping gas/lifting gas working fluid with the generation of geothermal power and with the generation of kinetic energy power using a positive displacement free-piston engine (256) to harness the total flow of pressurized fluids discharged from the well (210). Liquid phase carbon dioxide (202) is pumped to high pressure by a carbon dioxide liquid pump (206) that flows through liquid injection lines (208), being a coiled tubing or pipe stringer, extending at depth into a gas well (210) that penetrates through the sand and rocks of the earth (218) to a deep underground aquifer (212) containing large quantities of methane saturated brine water (204). The liquid miscible carbon dioxide (202) is pressurized into the flow of brine solution (204) and saturates the brine solution (204); then by direct heat exchange with the brine (204) the liquid carbon dioxide (202) boils to a high vapor pressure being a pressure equalizing gas in response to the thermal energy contained in the brine (204); and, thereby strips and separates the methane (200) from solution with the brine (204) as free methane gas (200) while under substantial pressure deep within the bore of the well (210).

The brine (204) flows from the reservoir (212) that is a the permeable aquifer (212) filled with methane (200) saturated brine solution (204) through the screen (214) or other forms of penetrations in the casing of the well (210). A total flow (216) of brine, methane gas (200), and carbon dioxide gas (202) under pressure are discharged from the well's casing (210) and flow into a separator pressure vessel (220) located at the surface of the earth (218). The difference in densities of the heavy liquid brine (204) and any other liquids that may be present such as heavy tar and oil as compared to the low density, light weight gases (200 & 202) allow the separator (220) to cause physical separation of the substances with the brine (204) being at the bottom of the unit (220) and the gases (200 & 202) being above the water (204) due to the differential in their specific densities.

The hot pressurized gases (200 & 202) flow out of the top of the separator (220) being at relatively high pressure into lines (222) to a ground loop heat exchanger (224) that rejects heat from the gases (200 & 202) to the shallow earth (218) just below the surface that remains at a cool (relative the temperature of the hot brine) near constant temperature year round. Cooling under pressure causes condensation of the carbon dioxide gas (202) to the liquid state while the natural gas (200) remains in the gaseous state. The liquid carbon dioxide (202) and the gaseous methane (200) flow into methane separator (226) and the relative specific densities of the two substances again allows separation. The pure methane gas (200) flows out of the separator under pressure such that additional compression is not needed for it to flow into gas transmission lines (not shown) where it is delivered to market. The liquid carbon dioxide (202) is withdrawn from the methane separator (226) into injector lines (208) by the liquid pump (206) and is pumped to higher pressure to again be injected into the flow of brine (204) at depth within the well (210) in a semi-closed continuous cycle that conserves the carbon dioxide working fluid (202).

The pressurized brine (204) after the methane (200) has been removed flows from the separator (220) flows through lines (230) in indirect heat exchange vaporizer (232) of an geothermal power unit organic Rankine cycle (ORC) in order to generate geothermal power using the thermal energy contained in the hot pressurized brine (204). Then flows to the spent brine injection well (246) and is discharged back into the aquifer (212) through screens (248) or other penetrations in the casing of the well (210) using its residual remaining pressure for reinjection without the need for supplemental pumping energy input. If the reservoir (212) has substantial geopressure the brine (212) would normally be placed in a shallower reservoir having less pressure. However, if the brine (204) is withdrawn by gas-lift pumping from the reservoir (212) at below or near hydrostatic pressure, it can easily flow back into same reservoir (212) using the artificial pressure produced by the high vapor pressure of the carbon dioxide gas (202).

The ORC liquid pump (254) withdraws liquid phase organic working fluid (234) from liquid reservoir (252) and pressurizes it through lines (228) into vaporizer (232) where the liquid (234) is vaporized into a pressurized gas (234) that flows to turbine (236) connected by a shaft (238) to an electrical generator (240) having an electrical power output (242). The spent working fluid (234) discharged from turbine (236) flows through lines (244) into a ground loop indirect heat exchanger (250) in order to reject heat to the near surface earth (218) that results in condensation of the working fluid (234) back to the liquid state, which then flows into liquid reservoir (252) to be pressurized by the liquid pump (254) in a continuous closed ORC cycle in order to generate geothermal power from the thermal energy contained in the brine (204). Power generated by the ORC unit may be used to drive the process by directly powering working fluid liquid pumps (206) to pump liquid carbon dioxide (202) to high pressure and/or gas compressors (not shown) to compress gaseous carbon dioxide (202) to high pressure; to power other equipment (not shown if any) used to separate the methane (200) from the brine (202). Electrical power output (242) may be used onsite or sold to the local utility.

The kinetic energy in the total flow of pressurized gases (200 and 202) and liquids (204) discharged from the well (210) are harnessed by a positive displacement free-piston engine (256) in order to produce mechanical power or is connected to an electrical generator (260) in order to generate an electrical power output (258). Produced power may be used to drive the process by directly powering working fluid liquid pumps (206) to pump liquid carbon dioxide (202) to high pressure and/or gas compressors (not shown) to compress gaseous carbon dioxide (202) to high pressure; to power other equipment (not shown if any) used to separate the methane (200) from the brine (202). Electrical power output (258) may be used onsite or sold to the local utility.

1. A method while under pressure for the separation of methane from brine solution with the production of hot water capable of generating geothermal power is hereby claimed comprising; a well in fluid communication with a water reservoir containing quantities of hot brine saturated with methane, a supply of gas-stripping/gas-lifting working fluid gas capable of being pressurized, selected from such pressure equalizing gas species as carbon dioxide, nitrogen, propane, ethane, etc., a pipe stringer or coiled tubing line capable of injecting the pressurized stripping gas/lifting gas into the flow of pressurized brine within the wellbore at depth in order to gas-strip the methane from the brine thereby effectively separating the methane from the brine water while under substantial pressure deep within the well bore and in order to simultaneously gas-lift pump pressurized hot water saturated with methane from the reservoir with the brine possessing useful thermal energy capable of generating power and being capable of providing heat for space heating and for many other conventional uses for which heat is commonly used; a suitable means of generating geothermal power from the thermal energy contained in the brine; and, a suitable means of harnessing the kinetic energy contained in the total flow of pressurized brine, methane gas and working fluid gas discharged from the well to produce mechanical power; a separator pressure vessel capable of collecting the liquid brine, methane gas, and pressurized stripping gas/lifting gas working fluid discharged from the well having a means of separating the brine water from the pressurized gases due to the variance in their specific densities; a suitable means of separating the methane gas from the stripping gas/lifting gas working fluid in a cycle in order to conserve the working fluid.

2. A method while under pressure for the separation of methane from brine solution with the production of hot water capable of generating geothermal power of claim 1 further comprising; a liquid carbon dioxide pump capable of pressurizing liquid carbon dioxide to high pressure, a pipe stringer or coiled tubing line capable of injecting the pressurized liquid carbon dioxide into the flow of pressurized brine located within the wellbore at depth in order to saturate the methane saturated brine with miscible liquid carbon dioxide and in order to gas-strip the methane from the brine as the liquid carbon dioxide boils to the gas phase in response to the thermal energy within the hot brine thereby effectively separating the methane from the brine water and in order to simultaneously gas-lift pressurized methane containing water from the reservoir; a separator pressure vessel capable of collecting the liquid brine, methane gas, and pressurized carbon dioxide gas discharged from the well having a means of separating the brine water from the gases due to the variance in their specific densities whereby the brine possesses useful thermal energy capable of generating power and being capable of providing heat for space heating and for many other conventional uses for which heat is commonly used; a suitable means of generating geothermal power from the thermal energy contained in the brine; and, a suitable means of harnessing the kinetic energy contained in the total flow of pressurized brine, methane gas and working fluid gas discharged from the well to produce mechanical power; a supply of liquid carbon dioxide or in the alternative a means of cooling and condensing the hot gaseous carbon dioxide to the liquid phase in a semi-closed cycle being a means of separating the liquid carbon dioxide from the gaseous methane and being a means of conserving and reusing the supply of carbon dioxide.

3. A method while under pressure for the separation of methane from brine solution with the production of hot water capable of generating geothermal power of claim 1 further comprising; a carbon dioxide gas compressor capable of compressing gaseous carbon dioxide to high pressure, a pipe stringer or coiled tubing line capable of injecting the pressurized gaseous carbon dioxide into the flow of pressurized brine within the wellbore at depth in order to gas-strip the methane from the hot brine thereby effectively separating the methane from the brine water while under substantial pressure deep within the well bore and in order to simultaneously gas-lift pressurized methane containing hot water from the reservoir; whereby the brine possesses useful thermal energy capable of generating power and being capable of providing heat for space heating, and for many other conventional uses for which heat is commonly used; a suitable means of generating geothermal power from the thermal energy contained in the brine; and, a suitable means of harnessing the kinetic energy contained in the total flow of pressurized brine, methane gas and working fluid gas discharged from the well to produce mechanical power; a separator pressure vessel capable of collecting the liquid brine, methane gas, and pressurized carbon dioxide gas discharged from the well having a means of separating the brine water from the gases due to the variance in their specific densities; a suitable means of separating the methane gas from the carbon dioxide gas; a supply of gaseous carbon dioxide or in the alternative a means of cooling and compressing gaseous carbon dioxide gas previously separated from the methane gas to high pressure in a semi-closed cycle being a means of reusing the supply of carbon dioxide.

4. A method while under pressure for the separation of methane from brine solution having a means of separating the methane gas from the stripping gas/lifting gas working fluid of claim 1 further comprising cooling the mixture of gases in order to accomplish heat rejection by suitable means selected from such species as an evaporative cooling tower, heat rejection to air, heat rejection to a ground loop indirect heat exchanger to reject heat to the near surface earth, etc. while under pressure in order to condense the stripping gas/lifting gas working fluid to the liquid phase while the natural gas remains in the gaseous form within a pressure vessel whereby the liquid working fluid is removed from the bottom of the separator vessel due to the variance in their specific densities and the methane gas is removed from the top of the vessel in order to separate the gases into a pure stream of pressurized natural gas that may be placed in a gas transmission line without further compression and a pure flow of liquid working fluid, which is pumped back into the wellbore in a continuous semi-closed cycle being a means of conserving and reusing the supply of working fluid.

5. A method while under pressure for the separation of methane from brine solution having a means of separating the methane gas from the stripping gas/lifting gas working fluid of claim 1 further comprising the use of ion selective membranes selected from such species as pressure swing or temperature swing absorption technology that selects either the carbon dioxide gas or the natural gas for separation from the other gas in order to separate the two gases.

6. A method while under pressure for the separation of methane from brine solution with the production of hot water capable of generating geothermal power of claim 1 further comprising; use of the thermal energy contained in the hot brine solution to generate power via organic Rankine cycle (ORC) conventional geothermal power technology further comprising; a liquid pump that pressurizes an organic working fluid into a vaporizer to generate pressurized vapor to drive a turbine connected by a shaft to an electrical generator having an electrical power output; a suitable means of cooling and heat rejection, selected from such species as an evaporative cooling tower, heat rejection to air, heat rejection to a ground loop indirect heat exchanger to reject heat to the near surface earth, etc. being capable of condensing the working fluid to the liquid state to again be pressurized by the liquid pump in a continuous closed ORC cycle in order to generate geothermal power from the thermal energy contained in the brine in order to generate power to drive the process by powering pumps to pump liquid carbon dioxide to high pressure and/or gas compressors to compress gaseous carbon dioxide to high pressure and to power any other equipment used to separate the methane from the brine and to generate additional electrical power that may be used or sold.

7. A method while under pressure for the separation of methane from brine solution and harnessing the kinetic energy contained in the total flow of pressurized brine, methane gas and working fluid gas discharged from the well of claim 1 further comprising use of an unconventional geothermal technology known as the “total flow concept” that harnesses the kinetic energy of the total flow of pressurized gases and liquids discharged from a well using the force of the pressurized fluids to drive a suitable prime mover, selected from such species as a free-piston engine, a turbo-expander, a multi-phase turbine, a twin screw expander, etc. in order to produce mechanical power used to power pumps to pump liquid carbon dioxide to high pressure and/or gas compressors to compress gaseous carbon dioxide to high pressure and to power any other equipment used to separate the methane from the brine and/or may be used in order to generate electrical power that may be used or sold.

8. A method while under pressure for the separation of methane from brine solution of claim 1 further comprising combustion of the methane gas separated from the brine solution in order to drive a gas-fired turbine engine in order to generate power and for the production of carbon dioxide gas to be used as the working fluid within the process with any excess carbon dioxide gas being sequestered into the earth along with the water reinjected into the reservoir in order to produce clean electrical power with no emissions; and, to provide a means of enhanced oil and gas recovery with the generation of electrical power by flooding a reservoir with water containing a high concentration of miscible carbon dioxide produced by the process of combustion of the separated methane.
